(19) United States
(12) Patent Application Publication
(10) Pub. No.: US 2025/0094529 A1
(43) Pub. Date: Mar. 20, 2025

(54) FAULT DETECTION FOR THE NTT

(71) Applicant: NXP B.V., Eindhoven (NL)

(72) Inventors: Melissa Azouaoui, Norderstedt (DE); Tobias Schneider, Graz (AT); Christine van Vredendaal, Veldhoven (NL)

(21) Appl. No.: 18/470,958

(22) Filed: Sep. 20, 2023

(51) Int. Cl. G06F 17/14

(52) U.S. Cl. CPC G06F 17/142

(57) ABSTRACT

A method for checking a computation of a discrete Fourier transform (DFT), including: computing a first layer of the DFT using a plurality of butterfly operations on inputs to the first layer to produce first outputs; computing a second layer of the DFT using a plurality of butterfly operations on the first outputs to produce second outputs; performing an invariant check on the first outputs after the computation of the second layer based upon the inputs to the first layer; and indicating a fault in the computation of the DFT when the invariant check fails.

### FIELD OF THE DISCLOSURE

Various exemplary embodiments disclosed herein relate to efficient fault detection generally for the discrete Fourier transform (DFT) and specifically for the number theoretic transform (NTT) and the fast Fourier transform (FFT) using fine-grained invariant checks.

### BACKGROUND

Recent significant advances in quantum computing have accelerated the research into post-quantum cryptography (PQC) schemes: cryptographic algorithms which run on classical computers but are believed to be still secure even when faced against an adversary with access to a quantum computer. This demand is driven by interest from standardization bodies such as the call for proposals for new public-key cryptography standards by the National Institute of Standards and Technology (NIST). The first stage of the selection procedure for a new cryptographic standard has ended and mainly the CRYSTALS-Kyber and CRYSTALS-Dilithium schemes, both based on the Module-Learning With Errors (MLWE) problem, have been selected by the NIST for standardization.

### SUMMARY

A summary of various exemplary embodiments is presented below.

Various embodiments relate to a method for checking a computation of a discrete Fourier transform (DFT), including: computing a first layer of the DFT using a plurality of butterfly operations on inputs to the first layer to produce first outputs; computing a second layer of the DFT using a plurality of butterfly operations on the first outputs to produce second outputs; performing an invariant check on the first outputs after the computation of the second layer based upon the inputs to the first layer; and indicating a fault in the computation of the DFT when the invariant check fails.

Various embodiments are described, wherein performing the invariant check includes comparing y₀−y₁ to 2ω·x₁ when the butterflies are Cooley Tukey (CT) butterflies, where y₀ and y₁ are outputs of the CT butterfly, x₁ is one of the inputs to the CT butterfly, and ω is a twiddle factor.

Various embodiments are described, wherein performing the invariant check includes comparing y₀+y₁ to 2x₀ when the butterflies are Cooley Tukey (CT) butterflies, where y₀ and y₁ are outputs of the CT butterfly and x₀ is one of the inputs to the CT butterfly.

Various embodiments are described, wherein performing the invariant check includes comparing ω⁻¹·(y₀−y₁) to 2x₁ when the butterflies are Cooley Tukey (CT) butterflies, where y₀ and y₁ are outputs of the CT butterfly, x₁ is one of the inputs to the CT butterfly, and ω is a twiddle factor.

Various embodiments are described, wherein performing the invariant check includes comparing ω·(y₀−2x₁) to y₁ when the butterflies are Gentleman-Sande (GS) butterflies, where y₀ and y₁ are outputs of the GS butterfly, x₁ is one of the inputs to the GS butterfly, and ω is a twiddle factor.

Various embodiments are described, wherein performing the invariant check includes comparing ω·(2x₀−x₀) to y₁ when the butterflies are Gentleman-Sande (GS) butterflies, where y₀ and y₁ are outputs of the GS butterfly, x₁ is one of the inputs to the GS butterfly, and ω is a twiddle factor.

Various embodiments are described, wherein performing the invariant check includes comparing (y₀−2x₁) to ω⁻¹·y₁ when the butterflies are Gentleman-Sande (GS) butterflies, where y₀ and y₁ are outputs of the GS butterfly, x₁ is one of the inputs to the GS butterfly, and ω is a twiddle factor.

Various embodiments are described, wherein performing the invariant check further includes comparing (2x₀-y₀) to ω⁻¹·y₁.

Various embodiments are described, wherein performing the invariant check includes comparing (2x₀−y₀) to ω⁻¹·y₁ when the butterflies are Gentleman-Sande (GS) butterflies, where y₀ and y₁ are outputs of the CT butterfly, x₁ is one of the inputs to the GS butterfly, and ω is a twiddle factor.

Various embodiments are described, wherein the DFT is a number theoretic transform.

Various embodiments are described, wherein the DFT is a fast Fourier transform.

Further various embodiments relate to a method for checking a computation of a discrete Fourier transform (DFT), including: computing a first layer of the DFT using a plurality of butterfly operations on inputs to the first layer to produce first outputs; computing a second layer of the DFT using a plurality of butterfly operations on the first outputs to produce second outputs; performing a check on the first outputs by recomputing the first layer of the DFT after the computation of the second layer based upon the inputs to the first layer; and indicating a fault in the computation of the DFT when the check fails.

Various embodiments are described, wherein the plurality of butterfly operations are Cooley Tukey (CT) butterflies.

Various embodiments are described, wherein the plurality of butterfly operations are Gentleman-Sande (GS) butterflies.

Various embodiments are described, wherein the DFT is a number theoretic transform.

Various embodiments are described, wherein the DFT is a fast Fourier transform.

Further various embodiments relate to a method for checking a computation of a discrete Fourier transform (DFT), including: computing a layer of the DFT using a plurality of butterfly operations on inputs to the layer to produce outputs; performing an invariant check on the outputs; and indicating a fault in the computation of the DFT when the invariant check fails.

Various embodiments are described, wherein performing the invariant check includes comparing y₀−y₁ to 2ω·x₁ when the butterflies are Cooley Tukey (CT) butterflies, where y₀ and y₁ are outputs of the CT butterfly, x₁ is one of the inputs to the CT butterfly, and ω is a twiddle factor.

Various embodiments are described, wherein performing the invariant check includes comparing y₀+y₁ to 2x₀ when the butterflies are Cooley Tukey (CT) butterflies, where y₀ and y₁ are outputs of the CT butterfly and x₀ is one of the inputs to the CT butterfly.

Various embodiments are described, wherein performing the invariant check includes comparing ω⁻¹·(y₀−y₁) to 2x₁ when the butterflies are Cooley Tukey (CT) butterflies, where y₀ and y₁ are outputs of the CT butterfly, x₁ is one of the inputs to the CT butterfly, and ω is a twiddle factor.

Various embodiments are described, wherein performing the invariant check includes comparing ω·(y₀−2x₁) to y₁ when the butterflies are Gentleman-Sande (GS) butterflies, where y₀ and y₁ are outputs of the GS butterfly, x₁ is one of the inputs to the GS butterfly, and ω is a twiddle factor.

Various embodiments are described, wherein performing the invariant check includes comparing ω·(2x₀−x₀) to y₁ when the butterflies are Gentleman-Sande (GS) butterflies, where y₀ and y₁ are outputs of the GS butterfly, x₁ is one of the inputs to the GS butterfly, and ω is a twiddle factor.

Various embodiments are described, wherein performing the invariant check includes comparing (y₀−2x₁) to ω⁻¹·y₁ when the butterflies are Gentleman-Sande (GS) butterflies, where y₀ and y₁ are outputs of the GS butterfly, x₁ is one of the inputs to the GS butterfly, and ω is a twiddle factor.

Various embodiments are described, wherein performing the invariant check further includes comparing (2x₀−y₀) to ω⁻¹·y₁.

Various embodiments are described, wherein performing the invariant check includes comparing (2x₀−y₀) to ω⁻¹·y₁ when the butterflies are Gentleman-Sande (GS) butterflies, where y₀ and y₁ are outputs of the CT butterfly, x₁ is one of the inputs to the GS butterfly, and ω is a twiddle factor.

Various embodiments are described, wherein the DFT is a number theoretic transform.

Various embodiments are described, wherein the DFT is a fast Fourier transform.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates how intermediate values of an NTT can be faulted.

FIG. 2 illustrates an NTT using deferred checking to detect faults in the intermediate results.

FIG. 3 illustrates an exemplary hardware diagram for implementing NTT with invariant checks.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of fault checking methods and systems for the calculation of the DFT, NTT, and FFT will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Recent significant advances in quantum computing have accelerated the research into post-quantum cryptography schemes: cryptographic algorithms which run on classical computers but are believed to be still secure even when faced against an adversary with access to a quantum computer. To-be-standardized cryptographic schemes Kyber and Dilithium are examples of these schemes. Notably in terms of practical implementations, their memory requirements are significantly higher than traditional schemes, like ECDH and ECDSA. This is not only due to large key/ciphertext/signature sizes but also to heavy usage of runtime memory to store intermediate values. In addition, their implementations on embedded devices require protection or countermeasures against side-channel and fault injection attacks.

One of the core operations of Kyber and Dilithium is the NTT, which is leveraged for faster polynomial multiplications. Fault countermeasures like re-computation have to be applied to it to prevent adversaries from extracting sensitive data through fault attacks. Re-computation of the NTT has a large negative impact on both memory and performances (roughly a factor 2).

It is noted that the NTT is a DFT over a ring. Hence, the NTT may be considered a specific example of DFT that is often implemented as a FFT. The invariant checks described below may be applied to different implementations of DFTs including NTTs and FFTs. The invariant checks disclosed below are described as NTTs because of the benefits provided in detecting faults in Kyber and Dilithium that use NTTs to speed up the calculation of polynomial multiplications but may be used with any DFT or FFT that utilizes butterflies.

In this disclosure, an invariant check based fault detection countermeasure for the NTT is presented. This fault detection method may be performed instead of fully re-computing the NTT which is costly for embedded devices because it leads to a 100% overhead for both speed and memory. The disclosed fault detection method is more efficient than re-computation and saves up to 40% of the operations and up to 50% of the required memory compared to straightforward re-computation.

When implementing Kyber or Dilithium, the main computationally expensive operations are arithmetic with polynomials with integer coefficients. For the purposes of this disclosure, computations are done in a ring R_{q}= [symbol] _{q}[X]/(Xⁿ+1) or R_{q}= [symbol] _{q}[X]/(Xⁿ−1) for positive integers q and n: the coefficients of the polynomials are in [symbol] _{q} while the polynomial arithmetic is modulo Xⁿ+1 or Xⁿ−1. These rings are used for the NIST finalists NTRU, Kyber, Saber, and Dilithium and may also be used for other proposals. Because q is prime for both Kyber and Dilithium, their implementations typically rely on NTTs to perform polynomial multiplication, which runs in [symbol] (n log (n)) time instead of the [symbol] (n²) complexity of many alternative multiplication methods.

Although NTTs come in various shapes and forms, the focus herein is on the setting where the coefficient ring is a finite field [symbol] _{q} of prime order q, and polynomials are taken modulo Xⁿ+1 for some n such that 2n|q−1. That is, the operations are carried out in the ring R_{q}= [symbol] _{q} [X]/(Xⁿ+1). Let ζ be a 2n-th primitive root of unity, which exists because 2n|q−1 and [symbol] _{q}⁺ is a cyclic group of order q−1. It follows that it is also a principal root of unity because the only square roots of 1 in [symbol] _{q} are 1 and −1. It follows that Xⁿ+1=(X−ζ)(X−ζ³) . . . (X−ζ²ⁿ⁻¹) and therefore that

$$NTT : {𝔽}_{q} [ X ] / ( {X}^{n} + 1 ) \to {\prod }_{i = 0}^{n - 1} {𝔽}_{q} [ X ] / ( X - {ζ}^{2 i + 1} ) f ↦ ( f ( {ζ}^{1} ) , … , f ( {ζ}^{2 n - 1} ) )$$

is an isomorphism by the Chinese Remainder Theorem (CRT). In practice, it is computed with exactly n/2·log (n) Cooley-Tukey (CT) butterflies, and its inverse NTT⁻¹ with n/2·log (n) Gentleman-Sande (GS) butterflies.

Embedded implementations of cryptographic schemes are exposed to physical attacks. These attacks include fault injection attacks, which are active techniques that inject a fault in the processing of the cryptographic function to recover information on the secret keys used. Post-quantum cryptographic schemes are not immune to such attacks. In particular, there are many operations in implementations of lattice-based schemes such as Kyber and Dilithium, that can be targeted by attackers. NTTs are among these sensitive targets. For example, an attacker can inject enough zeros in the processing of an NTT to zero out its output or manipulate its operations to result in a low entropy output, which can lead to key recovery. Other attacks rely on simply injecting a random fault in the NTT to randomize its output and perform differential fault attacks.

It is clear that it is necessary to protect the NTT operation in lattice-based schemes against fault attacks. The ad hoc countermeasure against fault attacks includes recomputing the target operation and comparing the results to detect any faults. However, this standard method has a few disadvantages. First, by recomputing the operation twice, a factor 2 overhead is incurred in terms of the number of operations or speed. Second, a factor 2 overhead is incurred in terms of memory because, even when only comparing hashes of the outputs, the input needs to be kept to perform the recomputation. The NTT is often performed in-place to reduce memory requirements, when computing it twice on the same input, the input needs to be duplicated. Finally, when computing the same operation twice, i.e., executing two identical operations, an attacker with a sophisticated fault injection setup can potentially succeed in injecting the same fault in both computation and hence bypass the countermeasure.

A fault detection countermeasure at the NTT butterfly level is described herein that includes performing specific invariant checks which are more computationally efficient than recomputing the butterfly. Different invariant checks for both CT and GS butterflies are described. Then, the fault detection rate of these new checks over the whole NTT are evaluated, it is noted that some faults cannot be detected by fine-grained butterfly recomputation or the fine-grained invariant checks described herein. Accordingly, a method is provided that catches those faults as well. For the full NTT, the disclosed fault detection method is more efficient, both in terms of the number of operations and the memory required, than the full recomputation of the NTT or fine-grained recomputations of the butterflies.

This fault detection method may be applied to any PQC scheme using the NTT such as Kyber and Dilithium. It may also be applied to schemes using the FFT such as Falcon. More generally, outside of the PQC scope, it may be applied to detect faults in NTT and FFT operations.

Recall from the introduction that the NTT and its inverse are computed by sequentially and in parallel applying a plurality of butterfly operations on the input. First what these operations look like is explained, and thereafter how the fault detection method prevents faults on these operations is explained.

First, CT butterfly invariant checks will be described. Recall that given two inputs x₀, x₁ and the twiddle constant ω, the outputs y₀, y₁ of a CT butterfly are computed as follows:

$$\begin{matrix}{y}_{0} = {x}_{0} + ω \cdot {x}_{1} \\ {y}_{1} = {x}_{0} - ω \cdot {x}_{1}\end{matrix} \qquad ( 1 )$$

To check that the butterfly has not been faulted, instead of recomputing it and comparing the results, performing one of the following invariant checks is suggested:

$${y}_{0} - {y}_{1} {=}^{?} 2 ω \cdot {x}_{1} \qquad ( 2 )$$

$${y}_{0} + {y}_{1} {=}^{?} 2 {x}_{0} \qquad ( 3 )$$

A simulation verified that only one of these checks is needed to detect faults on the butterfly level as long as the multiplication of x₁ with the twiddle constant is recomputed either in the check itself (as done in the first invariant check) or separately in the computation of each yᵢ (which should be done if the second invariant check is used). While the choice of invariant check is up to the implementer, the fault detection method disclosed herein is described using the first invariant check because it specifically detects faults on the twiddle factor multiplication by explicitly recomputing it. The CT butterfly is used in the further description of the fault detection method, but similar ideas, features and observations apply to the GS butterfly. The invariant checks for the GS butterfly are described in the next section.

Practical fault attacks can also fault the value of the twiddle constant before it is given as input to the butterfly. Naturally, recomputation or the proposed invariant checks would not detect this. Protecting the array of twiddle constants can be done using standard techniques e.g., a checksum over the twiddle constants.

Next, how the invariant checks may be modified to also detect faults on the twiddle constants will be described. The NTT uses the values of the twiddle constants, and the inverse NTT uses the inverses of the twiddle constants. In practice, only an array of the twiddle constants is stored and used, and based on the properties of the underlying ring, the inverses can be easily derived from the stored twiddle constants by applying a specific permutation to the stored array. The fault detection method takes advantage of this and detects faults on the twiddle constants. Concretely, in the CT butterfly in Equation 1, the invariant is checked using ω⁻¹ (which for Kyber and Dilithium implementations is a simple function of another element of the twiddle constants array). Specifically, it is checked if:

$${ω}^{- 1} \cdot ( {y}_{0} - {y}_{1} ) {=}^{?} 2 {x}_{1} \qquad ( 4 )$$

This means that if an attacker has faulted the value of w in the twiddle constants array, then the invariant check in Equation 4 can detect such a fault because a different element of the twiddle constants array is used. In a way, this different element acts as a redundant version of the twiddle constant used to compute the butterfly in the first place. To bypass this, an attacker is required to fault both values in the array.

The GS butterfly invariant checks will now be described. Recall that given two inputs x₀, x₁ and the twiddle constant ω, the outputs y₀, y₁ of a GS butterfly are computed as follows:

$${y}_{0} = {x}_{0} + {x}_{1} {y}_{1} = ω \cdot ( {x}_{0} - {x}_{1} )$$

While similar to the CT butterfly, the invariant checks of the GS butterfly are as follows:

$$ω \cdot ( {y}_{0} - 2 {x}_{1} ) {=}^{?} {y}_{1} ω \cdot ( 2 {x}_{0} - {y}_{0} ) {=}^{?} {y}_{1}$$

Using the inverse of the twiddle constant would result in the following two checks (note that now both checks may be performed, if desirable, at the cost of a single multiplication):

$$( {y}_{0} - 2 {x}_{1} ) {=}^{?} {ω}^{- 1} \cdot {y}_{1} ( 2 {x}_{0} - {y}_{0} ) {=}^{?} {ω}^{- 1} \cdot {y}_{1}$$

The invariant check is more efficient than recomputing the butterfly. For both the CT and the GS butterfly, performing one invariant check requires 4 operations: 1 multiplication, 1 addition, 1 comparison and 1 shift. Shifts are typically considered as free on the platforms targeted by this fault detection method, which yields an overhead of 3 operations per butterfly. On the other hand recomputation requires 5 operations: 1 multiplication, 2 additions and 2 comparisons.

The previous invariant checks may be performed for each butterfly in an NTT. However, these invariant checks or fine-grained recomputations of individual butterflies cannot detect all faults on the NTT. Specifically, faults in between stages of the NTT cannot be detected because the outputs of one stage are inputs to the following stage. Faulting the output of a stage before it is used as the input of the next cannot be detected by checking at the previous stage. The same holds for fine-grained recomputation. The intermediates can be faulted after they are recomputed and checked but before being used to compute the next stage.

FIG. 1 illustrates how intermediate values of an NTT can be faulted. The NTT 100 includes a first stage 102 and a second stage 104. The first stage 102 and second stage 104 include butterflies 106 and invariant checks 108. The first stage 102 receives inputs x₀, x₁, x₂, and x₃ and generates outputs y₀, y₁, y₂, and y₃. The outputs y₀, y₁, y₂, and y₃ are then input into the second stage 104 to produce outputs z₀, z₁, z₂, and z₃. In first stage 102 and second stage 104 after each butterfly 106 an invariant check 108 is performed. The butterflies 106 may be either CT or GS butterflies. The invariant checks 108 may be performed as described above depending upon the type of butterfly 106 used. The execution timeline 110 is an arrow illustrating the timeline of the NTT 100. In FIG. 1 a check mark indicates that the invariant checks 108 passed. In the example of FIG. 1, any faults injected in the butterflies 106 would be detected by the invariant checks 108. In FIG. 1 a fault 112 is injected to the value y₁ after the invariant checks 108 in the first stage 102. This sort of fault will not be detected by the invariant checks 108 in the first stage 102 or the second stage 104. The fault to y₁ will propagate through the second stage 104 without detection as checking z does not detect the fault because it was computed using the faulty value of y₁ and checked against that same faulty value. As a result the NTT 100 is still vulnerable to a fault attack on the intermediate results of the NTT 100.

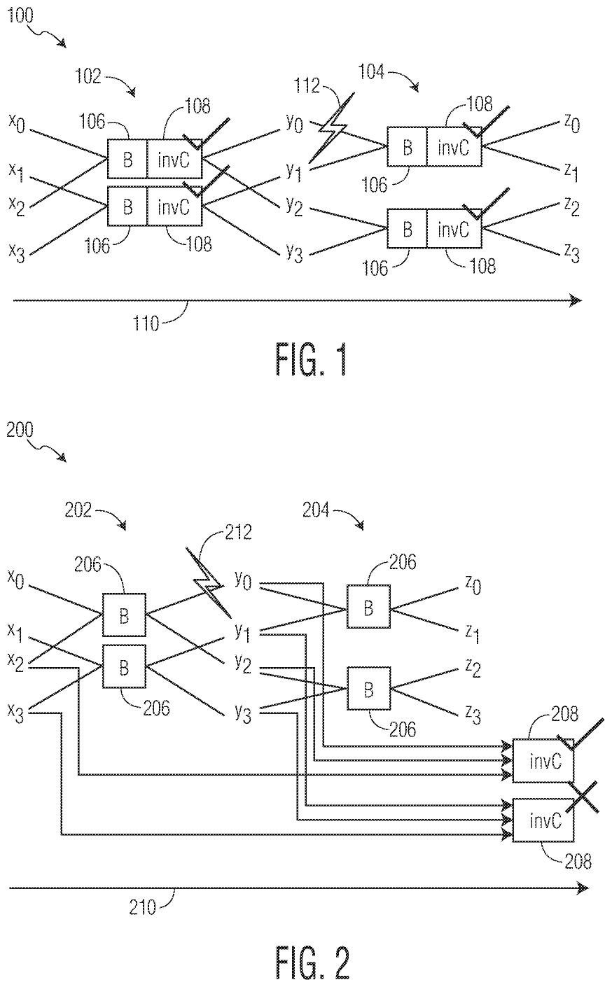

FIG. 2 illustrates an NTT using deferred checking to detect faults in the intermediate results. FIG. 2 illustrates a scheme or a scheduling of the butterfly invariant checks over the full NTT to also detect faults 212 in between stages. The main idea is based on performing the invariant checks on the intermediates only once they have been used to compute the next intermediates. In FIG. 2 an X means that the invariant check has not passed and that a fault 212 was detected. The execution timeline 210 is an arrow that specifies in which order the operations are performed.

The NTT 200 includes a first stage 202 and a second stage 204. The first stage 202 and second stage 204 include butterflies 206. The first stage 202 receives inputs x₀, x₁, x₂, and x₃ and generates outputs y₀, y₁, y₂, and y₃. The outputs y₀, y₁, y₂, and y₃ are then input into the second stage 204 to produce outputs z₀, z₁, z₂, and z₃. The butterflies 206 may be either CT or GS butterflies. In FIG. 2 the invariant checks 208 are only performed after the second stage 204 has completed.

The main idea illustrated in FIG. 2 is that a value is only checked once it has been used to compute its respective butterfly, i.e., the one it is an input to. First, it is noted that computing z₀ and z₁ requires y₀ and y₁. After computing z₀ and z₁, y₀ and y₁ are to be checked, however, to do so y₂ and y₃ are also required to check the correctness of y₀ and y₁, respectively. Because y₂ and y₃ are used to also compute z₂ and z₃, the invariant checks on y₀, y₁, y₂ and y₃ are only performed after z₀, z₁, z₂ and z₃ have been computed. This is shown by the execution timeline 210 and by the fact that the invariant checks 208 on y are to the right of the second stage butterflies. This helps to detect any fault on y that would have propagated to the stage computing z, and this fault would not have been detected otherwise. In addition, note that from an adversarial perspective, faulting y after the invariant checks on FIG. 2 is not advantageous because y is no longer used to compute intermediates of the NTT, and hence the fault would have no effect on the output of the NTT.

In another embodiment, the invariant checks 208 may be replaced with a complete recalculation of the butterflies 206. The delayed checking of the outputs of the butterflies 206 will detect the fault 212 on the intermediate results of the NTT 200. Accordingly, the check using the complete recalculation of the butterflies 206 will use all of the inputs x₀, x₁, x₂, and x₃ and intermediate results y₀, y₁, y₂ and y₃ to do the check. This means that the use of the delayed check may also be applied to the case where the check for faults includes complete recalculation of the butterflies 206 to also detect attacks on the intermediate results.

Based on the descriptions above, recomputing a butterfly requires 5 operations and performing one of the invariant checks requires 3 operations or 4 operations if shifts are not negligible. An NTT of degree n includes n/2·log (n) butterflies. Over this whole NTT, use of invariant checks yields a saving of (5−3)·n/2·log (n)=n·log (n) operations. For instance, on a general purpose CPU if additions and comparisons take 1 clock cycle each then 2048 clock cycles are saved when n=256. If shifts also cost 1 clock cycle then 1024 clock cycles are saved when n=256. This improvement is significant when considering how many NTT calls are needed to implement lattice-based cryptography schemes such as Kyber and Dilithium.

The use of the invariant checks also improves the amount of memory required to compute the NTT. Recall that recomputing the NTT requires the duplication of the input if the NTT is computed in-place to compare to the recomputed output. This leads to requiring memory for 2n elements instead of n elements. In the case of using the invariant checks, without deferral of the checks to the next stage, an additional 2 elements of temporary memory are required to perform the invariant check for each butterfly, leading to a maximum memory of n+2 (or n+3 if the inverse of the twiddle constant is used) elements per NTT. If the checks are deferred to the next stage as explained earlier, more memory is required, because for instance checking the elements of the NTT y state in FIG. 2 after computing z requires knowledge of half of the elements of x. These elements of x correspond to the variable x₁ in Equation 2. Eventually, for the whole NTT an additional n/2 elements are required to partially store the previous stage's input, which is later needed for the deferred checks. In addition, four temporary elements are required to compute and check the invariants. Accordingly, using invariant checks results in a memory overhead of n/2+4 (or n/2+5 if the inverses of the twiddle constants are used) elements in the worst case, instead of n elements when recomputing the NTT. Hence, the use of the invariant checks yields a memory saving of n−(n/2+4)=n/2−4 elements. For illustration, for n=256 and assuming elements are stored as 32 bit values, this corresponds to 496 bytes.

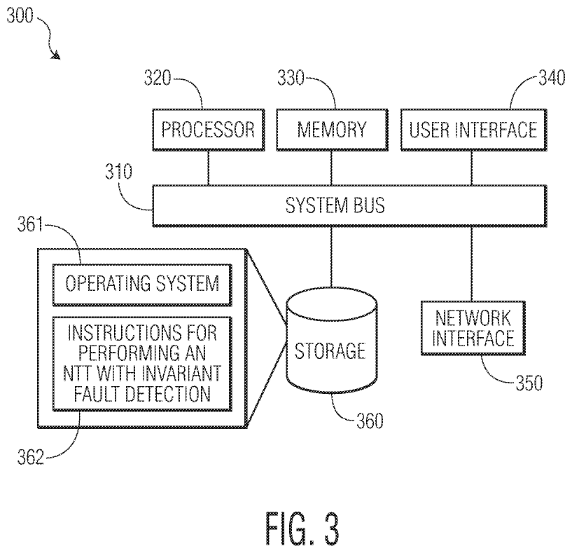

FIG. 3 illustrates an exemplary hardware diagram 300 for implementing NTT with invariant checks. The exemplary hardware 300 may correspond to the NTTs of FIG. 1 or FIG. 2. As shown, the device 300 includes a processor 320, memory 330, user interface 340, network interface 350, and storage 360 interconnected via one or more system buses 310. It will be understood that FIG. 3 constitutes, in some respects, an abstraction and that the actual organization of the components of the device 300 may be more complex than illustrated.

The processor 320 may be any hardware device capable of executing instructions stored in memory 330 or storage 360 or otherwise processing data. As such, the processor may include a microprocessor, microcontroller, graphics processing unit (GPU), neural network processor, field programmable gate array (FPGA), application-specific integrated circuit (ASIC), or other similar devices. The processor may be a secure processor or include a secure processing portion or core that resists tampering.

The memory 330 may include various memories such as, for example L1, L2, or L3 cache or system memory. As such, the memory 330 may include static random-access memory (SRAM), dynamic RAM (DRAM), flash memory, read only memory (ROM), or other similar memory devices. Further, some portion or all of the memory may be secure memory with limited authorized access and that is tamper resistant.

The user interface 340 may include one or more devices for enabling communication with a user. For example, the user interface 340 may include a display, a touch interface, a mouse, and/or a keyboard for receiving user commands. In some embodiments, the user interface 340 may include a command line interface or graphical user interface that may be presented to a remote terminal via the network interface 350.

The network interface 350 may include one or more devices for enabling communication with other hardware devices. For example, the network interface 350 may include a network interface card (NIC) configured to communicate according to the Ethernet protocol or other communications protocols, including wireless protocols. Additionally, the network interface 350 may implement a TCP/IP stack for communication according to the TCP/IP protocols. Various alternative or additional hardware or configurations for the network interface 350 will be apparent.

The storage 360 may include one or more machine-readable storage media such as read-only memory (ROM), random-access memory (RAM), magnetic disk storage media, optical storage media, flash-memory devices, or similar storage media. In various embodiments, the storage 360 may store instructions for execution by the processor 320 or data upon with the processor 320 may operate. For example, the storage 360 may store a base operating system 361 for controlling various basic operations of the hardware 300. The storage 362 may include instructions for carrying out the NTT with invariant fault detection.

It will be apparent that various information described as stored in the storage 360 may be additionally or alternatively stored in the memory 330. In this respect, the memory 330 may also be considered to constitute a “storage device” and the storage 360 may be considered a “memory.” Various other arrangements will be apparent. Further, the memory 330 and storage 360 may both be considered to be “non-transitory machine-readable media.” As used herein, the term “non-transitory” will be understood to exclude transitory signals but to include all forms of storage, including both volatile and non-volatile memories.

The system bus 310 allows communication between the processor 320, memory 330, user interface 340, storage 360, and network interface 350.

While the host device 300 is shown as including one of each described component, the various components may be duplicated in various embodiments. For example, the processor 320 may include multiple microprocessors that are configured to independently execute the methods described herein or are configured to perform steps or subroutines of the methods described herein such that the multiple processors cooperate to achieve the functionality described herein.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method for checking a computation of a discrete Fourier transform (DFT), comprising:
computing a first layer of the DFT using a plurality of butterfly operations on inputs to the first layer to produce first outputs;
computing a second layer of the DFT using a plurality of butterfly operations on the first outputs to produce second outputs;
performing an invariant check on the first outputs after the computation of the second layer based upon the inputs to the first layer; and
indicating a fault in the computation of the DFT when the invariant check fails.

2. The method of claim 1, wherein performing the invariant check includes comparing y₀−y₁ to 2ω·x₁ when the butterflies are Cooley Tukey (CT) butterflies, where y₀ and y₁ are outputs of the CT butterfly, x₁ is one of the inputs to the CT butterfly, and w is a twiddle factor.

3. The method of claim 1, wherein performing the invariant check includes comparing y₀+y₁ to 2x₀ when the butterflies are Cooley Tukey (CT) butterflies, where y₀ and y₁ are outputs of the CT butterfly and x₀ is one of the inputs to the CT butterfly.

4. The method of claim 1, wherein performing the invariant check includes comparing ω⁻¹·(y₀−y₁) to 2x₁ when the butterflies are Cooley Tukey (CT) butterflies, where y₀ and y₁ are outputs of the CT butterfly, x₁ is one of the inputs to the CT butterfly, and ω is a twiddle factor.

5. The method of claim 1, wherein performing the invariant check includes comparing ω·(y₀−2x₁) to y₁ when the butterflies are Gentleman-Sande (GS) butterflies, where y₀ and y₁ are outputs of the GS butterfly, x₁ is one of the inputs to the GS butterfly, and ω is a twiddle factor.

6. The method of claim 1, wherein performing the invariant check includes comparing ω·(2x₀−x₀) to y₁ when the butterflies are Gentleman-Sande (GS) butterflies, where y₀ and y₁ are outputs of the GS butterfly, x₁ is one of the inputs to the GS butterfly, and w is a twiddle factor.

7. The method of claim 1, wherein performing the invariant check includes comparing (y₀−2x₁) to ω⁻¹·y₁ when the butterflies are Gentleman-Sande (GS) butterflies, where y₀ and y₁ are outputs of the GS butterfly, x₁ is one of the inputs to the GS butterfly, and ω is a twiddle factor.

8. The method of claim 7, wherein performing the invariant check further includes comparing (2x₀−y₀) to ω⁻¹·y₁.

9. The method of claim 1, wherein performing the invariant check includes comparing (2x₀−y₀) to ω⁻¹·y₁ when the butterflies are Gentleman-Sande (GS) butterflies, where y₀ and y₁ are outputs of the CT butterfly, x₁ is one of the inputs to the GS butterfly, and ω is a twiddle factor.

10. The method of claim 1, wherein the DFT is a number theoretic transform.

11. The method of claim 1, wherein the DFT is a fast Fourier transform.

12. A method for checking a computation of a discrete Fourier transform (DFT), comprising:
computing a first layer of the DFT using a plurality of butterfly operations on inputs to the first layer to produce first outputs;
computing a second layer of the DFT using a plurality of butterfly operations on the first outputs to produce second outputs;
performing a check on the first outputs by recomputing the first layer of the DFT after the computation of the second layer based upon the inputs to the first layer; and
indicating a fault in the computation of the DFT when the check fails.

13. The method of claim 12, wherein the plurality of butterfly operations are Cooley Tukey (CT) butterflies.

14. The method of claim 12, wherein the plurality of butterfly operations are Gentleman-Sande (GS) butterflies.

15. The method of claim 12, wherein the DFT is a number theoretic transform.

16. The method of claim 12, wherein the DFT is a fast Fourier transform.

17. A method for checking a computation of a discrete Fourier transform (DFT), comprising:
computing a layer of the DFT using a plurality of butterfly operations on inputs to the layer to produce outputs;
performing an invariant check on the outputs; and
indicating a fault in the computation of the DFT when the invariant check fails.

18. The method of claim 17, wherein performing the invariant check includes comparing y₀−y₁ to 2ω·x₁ when the butterflies are Cooley Tukey (CT) butterflies, where y₀ and y₁ are outputs of the CT butterfly, x₁ is one of the inputs to the CT butterfly, and w is a twiddle factor.

19. The method of claim 17, wherein performing the invariant check includes comparing y₀+y₁ to 2x₀ when the butterflies are Cooley Tukey (CT) butterflies, where y₀ and y₁ are outputs of the CT butterfly and x₀ is one of the inputs to the CT butterfly.

20. The method of claim 17, wherein performing the invariant check includes comparing ω⁻¹·(y₀−y₁) to 2x₁ when the butterflies are Cooley Tukey (CT) butterflies, where y₀ and y₁ are outputs of the CT butterfly, x₁ is one of the inputs to the CT butterfly, and ω is a twiddle factor.

21. The method of claim 17, wherein performing the invariant check includes comparing ω·(y₀−2x₁) to y₁ when the butterflies are Gentleman-Sande (GS) butterflies, where y₀ and y₁ are outputs of the GS butterfly, x₁ is one of the inputs to the GS butterfly, and ω is a twiddle factor.

22. The method of claim 17, wherein performing the invariant check includes comparing ω·(2x₀−x₀) to y₁ when the butterflies are Gentleman-Sande (GS) butterflies, where y₀ and y₁ are outputs of the GS butterfly, x₁ is one of the inputs to the GS butterfly, and ω is a twiddle factor.

23. The method of claim 17, wherein performing the invariant check includes comparing (y₀−2x₁) to ω⁻¹·y₁ when the butterflies are Gentleman-Sande (GS) butterflies, where y₀ and y₁ are outputs of the GS butterfly, x₁ is one of the inputs to the GS butterfly, and ω is a twiddle factor.

24. The method of claim 23, wherein performing the invariant check further includes comparing (2x₀−y₀) to ω⁻¹·y₁.

25. The method of claim 17, wherein performing the invariant check includes comparing (2x₀−y₀) to ω⁻¹·y₁ when the butterflies are Gentleman-Sande (GS) butterflies, where y₀ and y₁ are outputs of the CT butterfly, x₁ is one of the inputs to the GS butterfly, and ω is a twiddle factor.

26. The method of claim 17, wherein the DFT is a number theoretic transform.

27. The method of claim 17, wherein the DFT is a fast Fourier transform.
